(19) United States
(12) Patent Application Publication
(10) Pub. No.: US 2016/0364703 A1
(43) Pub. Date: Dec. 15, 2016

(54) Systems and Methods for Verifying Users, in Connection With Transactions Using Payment Devices

(71) Applicant: MASTERCARD INTERNATIONAL INCORPORATED, Purchase, NY (US)

(72) Inventors: Sumeet Bhatt, Jericho, NY (US); John Beric, London (GB); Jean-Louis Rouquet, Frasnes-lez-Gosselies (BE); Jean-Paul Edmond Rans, Glabais (BE)

(21) Appl. No.: 15/061,077

(22) Filed: Mar. 4, 2016

Related U.S. Application Data
(60) Provisional application No. 62/173,144, filed on Jun. 9, 2015.

(51) Int. Cl. G06Q 20/10; G06Q 20/38; G06Q 20/40

(52) U.S. Cl. CPC G06Q 20/105; G06Q 20/40145; G06Q 20/38215; G06Q 2220/00

(57) ABSTRACT

Systems and methods for verifying users in connection with transactions using payment devices, by which benefits are distributed, are disclosed. One exemplary method generally includes initiating a timer after power-up of a security chip by a terminal, capturing a biometric of a user, at a biometric sensor associated with the security chip, and comparing, by the security chip, the captured biometric to a reference biometric. When the time is unexpired, and the captured biometric matches the reference biometric, the method includes launching a biometric application, whereby the terminal appends a first account number to an authorization request for a transaction to the payment account, when the timer is expired, the method includes launching a standard payment application, whereby the terminal includes a second account number in an authorization request for a transaction to the payment account, the first account number is different than the second account number.

### CROSS-REFERENCE TO RELATED APPLICATION

This application claims the benefit of, and priority to, U.S. Provisional Application No. 62/173,144 filed on Jun. 9, 2015. The entire disclosure of the above application is incorporated herein by reference.

### FIELD

The present disclosure generally relates to systems and methods for verifying users, in connection with transactions using payment devices, prior to distributing benefits to the users (e.g., products, payments, etc.).

### BACKGROUND

This section provides background information related to the present disclosure which is not necessarily prior art.

Payment account cards are often used by individuals in financial transactions such as, for example, the purchase of goods and/or services (broadly, products) from merchants, etc. The same payment account cards, or different cards, may also be used to access funds (e.g., ATM cards, etc.), and/or to transfer funds from sources into payment accounts associated with the cards. Further, benefits such as social assistance, etc. are known to be provided to the payment accounts, and accessed via the payment account cards. Separately, a variety of card verification methods are generally used to ensure that the users of the payment account cards are in fact authorized to use them. Known card verification methods include user signatures and personal identification numbers (PINs).

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in verifying a user in connection with a transaction using a payment device;

FIG. 2 is a block diagram of an exemplary computing device, that may be used in the system of FIG. 1;

FIG. 3 is a block diagram of an exemplary payment device, that may be used in the system of FIG. 1; and

FIG. 4 is an exemplary method, suitable for use with the system of FIG. 1, for permitting verification of a user prior to a transaction by the user involving a payment device.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Verification of users may be required, or desired, prior to distributing benefits to the users (e.g., prior to distributing products, payments, etc. to the users). The verification methods may vary for different payment accounts, depending on, for example, requirements implemented by sources of the benefits being distributed and/or entities controlling the payment accounts. Systems, devices and methods herein provide biometric verification of users, which is used by issuers of the payment accounts, or by others, to load benefits (e.g., payments, funds, etc.) to the accounts and to permit withdrawal of benefits from the accounts, etc. Exemplary devices, usable as described herein, incorporate security chips (e.g., EMV chips, etc.) with biometric sensors (e.g., fingerprint sensors, etc.), into payment devices (e.g., payment cards). The security chips act to verify the users, if possible, by use of the biometric sensors and then, if verified, provide transactions, through which the verifications are confirmed, to the issuers of the payment accounts. The issuers, in turn, may approve benefits (e.g., loading funds to the users' payment accounts, releasing goods or services to the users, etc.) based on the verifications. In this manner, the identities of the account users are verified, with significant confidence, before the benefits are “paid” (or distributed) to the users.

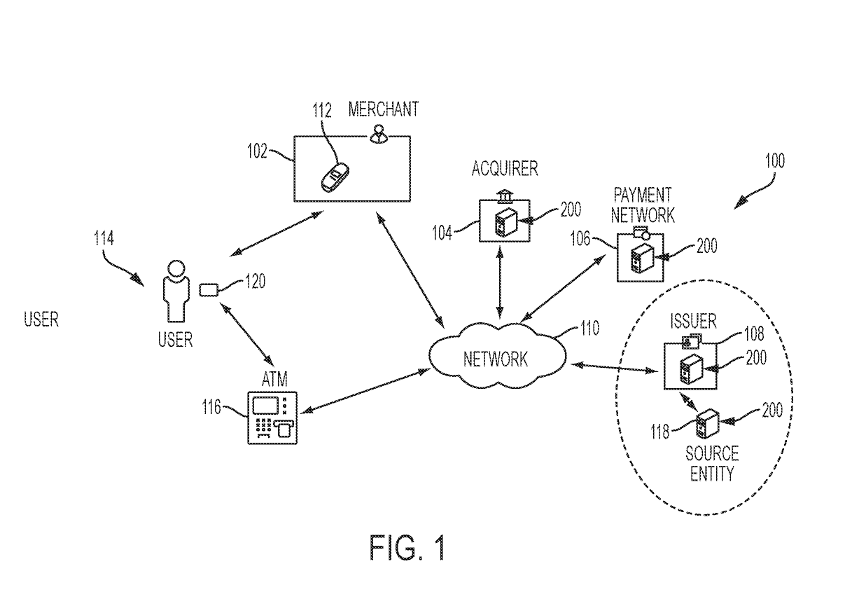

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, depending on, for example, processes involved in verification of payment account users, etc.

As shown in FIG. 1, the illustrated system 100 generally includes a merchant 102, an acquirer 104 associated with the merchant 102, a payment network 106, and an issuer 108 of payment accounts, each coupled to (and in communication with) network 110. The merchant 102 includes a point-of-sale (POS) terminal 112, which permits transactions funded by payment accounts. The system 100 also includes user 114, who can interact with the merchant 102, and in particular, the POS terminal 112 to facilitate transactions between the merchant 102 and the user 114 for products and/or other benefits, from the merchant 102, including, for example, goods and services. In addition, the system 100 includes an ATM (automated teller machine) terminal 116, which is provided to perform financial transactions such as cash withdrawals or deposits, and/or status or balance inquires, etc., by the user 114 with the issuer 108.

In this exemplary embodiment, the system 100 further includes a source entity 118. As indicated by the dotted lines, the source entity 118 is associated with, or integrated with, the issuer 108. The source entity 118 is, generally, a source of benefits to be distributed to the user 114. The benefits may be any different type of goods, services, payments, cash, etc., to be funded to payment accounts associated with user 114 or distributed to the user 114 at the merchant 102, for example. The benefits may further include, for example, social benefits, such as, government assistance, or tax refunds, either of which is paid by one or more government agencies, or other entities, etc. With that said, the source entity 118 may include any source of such benefits to be distributed to the user 114 or the user's account, for which verification of the user 114 may be required, or desired, prior to distribution.

While only one merchant 102 and one user 114 are illustrated in FIG. 1, it should be appreciated that any number of merchants and/or users, as described herein, may be included in different embodiments. Likewise, a different number of terminals (e.g., POS, ATM, or otherwise, etc.), acquirers, payment networks, issuers, and source entities may be included. The merchant 102 will often include multiple POS terminals, for example. In other embodiments, different merchants may have different acquirers, and different users may employ payment accounts issued by multiple different issuers. Further, in other embodiments, different source entities may be associated with different sources or manners of distribution to the user 114, or the user's payment account(s).

In the system 100, the merchant 102 and the issuer 108 are also associated, to the extent the merchant 102 is obligated and/or willing to accept identification transactions for the issuer 108 (i.e., transactions that may not include a product purchase/return). Based on the association, the POS terminal 112, or merchant 102, includes some indicia that the merchant 102 is a location willing and/or able to perform identification transactions for the user 114. At the merchant 102, therefore, the user 114 is generally able to complete two types of transactions: identification transactions (in which fingerprint verification is necessary), and other purchase transactions (in which fingerprint verification may or may not be used). An identification transaction may be just verification of the user 114, or it may additionally include the purchase of goods or services from the merchant 102.

Referring still to FIG. 1, the network 110 of the system 100 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. In addition, the network 110 may include multiple networks, where different ones of the multiple networks are accessible to different ones of the illustrated parts in FIG. 1. For example, the network 110 may include a private payment transaction network provided by the payment network 106 to the acquirer 104 and the issuer 108, and separately, a public network (e.g., the Internet, etc.) through which the merchant 102, ATM terminal 116, and/or the user 114 communicate, therebetween, or with the acquirer 104, the payment network 106, or the issuer 108.

It should be appreciated that, in the system 100, the POS terminal 112 is connected to the issuer 108, via network 110, and is thereby able to perform “online” transactions. In other embodiments, however, if a POS terminal is “offline,” and/or unconnected to an issuer, verification, as described herein, may not be permitted or possible.

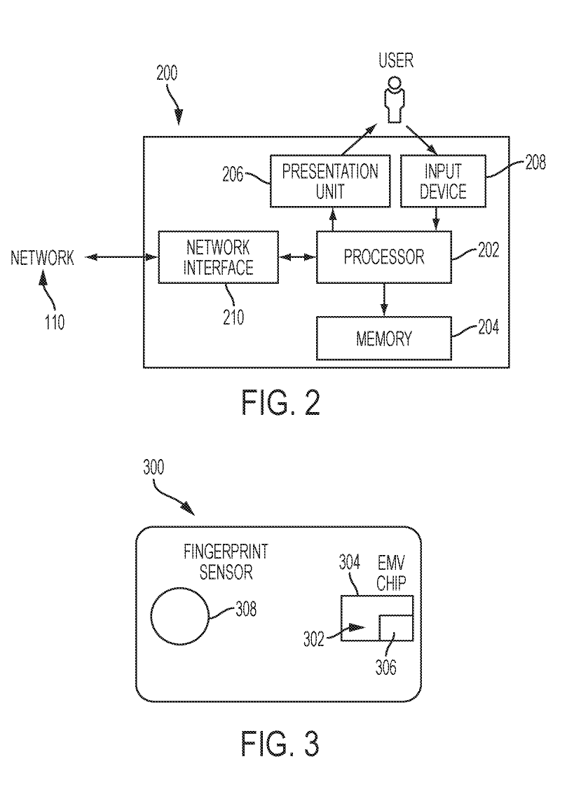

Each of the acquirer 104, the payment network 106, the issuer 108, the POS terminal 112, the ATM terminal 116, and the source entity 118 in the system 100 is associated with, or implemented in, one or more computing devices. For illustration, the system 100 is described herein with reference to exemplary computing device 200, illustrated in FIG. 2. Each of the acquirer 104, the payment network 106, the issuer 108, the POS terminal 112, the ATM terminal 116, and the source entity 118 in the system 100 is associated with, or is implemented in, such a computing device 200. However, the system 100 and its parts should not be considered limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region, such that, for example, each computing device 200 in the system 100 may represent multiple computing devices (so long as the computing devices are specifically configured to operate as described herein).

By way of example (and without limitation), the exemplary computing device 200 may include one or more servers, personal computers, laptops, tablets, PDAs, telephones (e.g., cellular phones, smartphones, other phones, etc.), POS terminals, ATM terminals, combinations thereof, etc., as appropriate and/or as described herein.

With reference now to FIG. 2, the computing device 200 generally includes a processor 202, and a memory 204 that is coupled to (and in communication with) the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may be configured to store, without limitation, transaction data, payment account numbers (e.g., PAN, PAN+PSN, etc.), reference biometrics, cryptograms, authorization messages, authorization response messages, and/or other types of data suitable for use as described herein, etc. In addition, the memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), CD-ROMs, thumb drives, tapes, flash drives, hard disks, and/or any other type of volatile or nonvolatile physical or tangible computer-readable media. It should be appreciated that the memory 204 may include a variety of different memories.

In various embodiments, computer-executable instructions may be stored in the memory 204 for execution by the processor 202 to cause the processor 202 to perform one or more of the operations described herein, such that the memory 204 is a physical, tangible, and non-transitory computer-readable media.

The computing device 200 also includes a presentation unit 206 and an input device 208 coupled to (and in communication with) the processor 202.

The presentation unit 206 outputs information and/or data to a user (e.g., the user 114, other users, etc.) by, for example, displaying, audibilizing, and/or otherwise outputting the information and/or data. In some embodiments, the presentation unit 206 may comprise a display device such that various interfaces (e.g., application screens, webpages, etc.) may be displayed at computing device 200, and in particular at the display device, to display such information and/or data, etc. With that said, the presentation unit 206 may include, without limitation, a cathode ray tube (CRT), a liquid crystal display (LCD), a light-emitting diode (LED) display, an organic LED (OLED) display, an “electronic ink” display, speakers, combinations thereof, etc. In addition, the presentation unit 206 may include multiple devices in some embodiments.

The input device 208, when present in the computing device 200, is configured to receive input from the user 114. The input device may include, without limitation, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both a display device and an input device.

The illustrated computing device 200 also includes a network interface 210 coupled to (and in communication with) the processor 202 and the memory 204. The network interface 210 may include, without limitation, a wired network adapter, a wireless network adapter, a mobile adapter, or other device capable of communicating to one or more different networks (e.g., the Internet, a private or public LAN, WAN, mobile network, combinations thereof, or other suitable network, etc.) that is either part of the network 110, or separate therefrom. In some exemplary embodiments, the processor 202 and one or more network interfaces may be incorporated together.

Referring again to FIG. 1, the system 100 further includes a payment device 120, for use at one or multiple different terminals, including POS terminal 112 and ATM terminal 116, to perform as described herein. The payment device 120 is associated, specifically, with user 114 in the system 100 and is provided by the issuer 108. In addition, the payment device 120 is associated with a payment account, issued by the issuer 108. The payment account has a primary account number (or PAN), or multiple PAN's or a PAN+PSN (PAN sequence number), which is indicated by the payment device 120. The PAN of the payment device 120, or one of its PAN's or PAN+PSN, is in a range of PAN's recognized by the issuer 108 as a payment account, for which fingerprint verification applies, as described herein. And, the payment account associated with the payment device 120 also is the account to which benefits are distributed from source entity 118, as described herein.

For purposes of the description herein, the payment device 120, shown in FIG. 1, may be a payment device consistent with exemplary payment device 300, illustrated in FIG. 3. For example, the payment device 300 may include a credit card, a debit card, an ATM card, a pre-paid card, or other device, which includes a security chip (e.g., EMV chip, etc.). However, it should be appreciated that the systems herein should not be understood to be limited to the payment device 300, as depicted in FIG. 3, as different payment devices may be used.

As shown in FIG. 3, the illustrated payment device 300 includes a security chip 302, which may include a contact and contactless chip and, as illustrated, incorporate a processor 304 and memory 306. The security chip 302 is an EMV (Europay®, MasterCard® and Visa®) chip, in the illustrated payment device 300. In the illustrated embodiment, a single security chip 302 is provided in payment device 300. However, multiple such chips may be included in other embodiments. In addition, in at least one embodiment, the security chip 302 includes multiple processors, each located in a different security chip 302, and with each chip handling one or more of the operations described herein.

Moreover, the processor 304 and memory 306 associated with the security chip 302 (or multiple security chips 302) are often formed integrally, for manufacturability and size constraints associated with the payment device 300. It should further be appreciated that the processor 304 can include one or more suitable processing units, such as described above, and the memory 306 can include any suitable devices, such as described above, that enable the functions described herein. In this particular embodiment, the memory 306 includes both volatile memory and non-volatile memory, such that application instructions and a reference biometric are permanently stored in memory 306 (i.e., non-volatile memory), while workspace memory (e.g., memory in which intermediate calculations, for example, are stored) is lost upon loss of power to the payment device 300, or is not permanent (i.e., volatile memory). Further, the payment device 300 is subject to and complies with, in this embodiment, the ISO/IEC 7810 ID-1 standard, which generally indicates the physical dimensions and/or dimensional proportions of the payment device 300 (i.e., a payment card in this instance). Of course, however, other payment device embodiment may be constructed according to one or more other standards.

In addition, the payment device 300 includes a fingerprint sensor 308 used to verify a user (e.g., the user 114, etc.). The fingerprint sensor 308, as shown in FIG. 3, is located on an opposite side (or an opposite end portion) of the payment device 300, from the security chip 302. In this manner, the payment device 300 may be partially inserted into the POS terminal 112 or the ATM terminal 116 (or other terminal or device reader), whereby the terminal 112 or 116 is able to interface with or contact the security chip 302, while the fingerprint sensor 308 remains outside the terminal and/or accessible to the user 114. Interaction between the security chip 302 and the POS terminal 112, for example, is described in more detail hereinafter with reference to method 400. Further, while a fingerprint sensor 308 is included in the payment device 300, it should be appreciated that other suitable biometric readers (included in or apart from the payment device 300 in a POS terminal, for example) may be used in other embodiments.

With continued reference to FIG. 3, in this embodiment, the security chip 302 of the payment device 300 is configured to select between and execute at least three different applications: a verification application, a biometric application, and a standard payment application. The later applications are identified by a root application identifier (AID), followed by a proprietary application identified extension, or PIX (specific to the particular application), and forming a “long” AID. The payment device 300 may further include an order of execution of the applications, which in this embodiment, includes the standard payment application with a higher priority than the biometric application, with each being subject to the verification application. That is, the payment device 300 includes a priority indicator for each of the above applications, allowing a POS terminal to elaborate a list with order of preference, whereby the ordinary standard payment application is selected if the biometric verification fails, while the biometric application is selected otherwise.

Different operations, as described herein, may be implemented within the security chip 302 as hardware, or firmware, or software in the form of executable instructions.

In general, the security chip 302 is powered from the POS terminal 112, in which it is inserted. Upon power-up, the chip 302 is configured, via the processor 304, etc., to perform verification of the user 114, by capturing a fingerprint, via fingerprint sensor 308 (by the user 114 swiping or touching the sensor 308), formatting the captured fingerprint, as needed, and comparing the captured fingerprint to a reference fingerprint stored in memory 306, prior to expiration of a counter. In particular, after powering, the security chip 302 initiates a counter of waiting time extensions (WTX) requests, which provide sufficient time for the user 114 to provide a fingerprint to the fingerprint sensor 308. The payment device 300 responds to the WTX request, while the verification application is being executed (and the counter is not expired), but generally ignores other commands (i.e., it only responds as necessary to delay one or more errors, while executing the verification application). If the verification fails (e.g., the fingerprint sensor 308 is not accessible to the user 114, or the fingerprint sensor 308 fails to capture a matching fingerprint, etc.), the security chip 302 transmits the AID for the standard payment application to the POS terminal 112, for example, which is then automatically selected. The standard payment application may rely on one or more other card verification methods (CVMs), including, for example, offline PIN, online PIN, signature, no CVM, etc.

In numerous embodiments, upon successful verification of the user 114, the security chip 302 proceeds with launching the biometric application, whereby there is no user and/or attendant selection of application at the POS terminal, as the selection is explicit based on the result of the verification application. In at least one embodiment, however, upon successful verification of the user 114, via the fingerprint sensor 308, the security chip 302 may set the fingerprint verified field in memory 306, and in response to the user 114, or merchant attendant, may transmit AIDs for the biometric application and the standard payment application to the POS terminal 112, for example, from which, the user is permitted to select between a biometric payment transaction and a standard purchase transaction.

In addition, upon successful verification of the user 114, among other operations consistent with one or more EMV standards (and/or M/Chip® requirements), the security chip 302 is configured to generate an Application Cryptogram (AC) which can either be a Transaction Certificate (TC) if the transaction is approved off-line from the payment network 106 or an Authorization Request Cryptogram (ARQC) if the transaction is approved on-line to the issuer 108. The AC is based on data including the fingerprint verified field being set or not set. If the transaction is authorized on-line, then the ARQC is passed, by the payment device 300, to the POS terminal 112. The POS terminal 112 in turn generates an authorization request (including the cryptogram) and transmits it to the issuer 108, via the acquirer 104 and payment network 106. In turn, the issuer 108 provides an authorization response cryptogram (ARPC) back through the system 100 to the payment device 300, which is then verified by the security chip 302. In connection with the authentication request, it may happen that the acquirer 104 truncates a part of the authorization request related to the verified fingerprint, e.g., DE55, etc., when the acquirer 104 (e.g., the computing device 200 associated with the acquirer 104, etc.) is not capable of carrying it through the payment network 106 to the issuer 108. To compensate, the payment network 106 and/or the issuer 108 may edit the authorization request content by adding SE 17, based on the PAN registration or the PAN and a PAN+PSN for the user's account, being within a range associated with identification transaction payment devices (as known to the payment network 106 and/or the issuer 108).

Further, upon power-up of the payment device 300 and security chip 302, for the first time, the memory 306 does not include reference fingerprint data. In several embodiments, the security chip 302 is configured to store a first fingerprint, captured at fingerprint sensor 308, as processed into fingerprint data, as the reference fingerprint data. As such, the reference fingerprint (and, broadly, the reference biometric data) is specific/particular to the payment device 300 (as opposed to being stored outside the payment device 120, at a central repository, etc.). In general, the payment device 300 ignores other commands while storing the reference fingerprint data. It should be appreciated that a variety of other manners of identifying the payment device 300 to the user 114 and/or storing reference fingerprint data or other biometric, as provided by one or more enrollment procedures, may be employed, potentially, as prescribed by the issuer 108 (or source entity 118 or manufacturer of the payment device 300).

Also, after verification of the user 114, regardless of the application selected (i.e., whether the user 114 is verified or not), applications in the payment device 300 include different lists of acceptable CVMs, which, in this embodiment, include biometric verification, and any other CVM's generally acceptable by the issuer 108 for seeking authorization of transactions (e.g., personal identification number (PIN), offline PIN, online PIN, signature, no CVM, etc.). For example, the CVM list, for biometric applications, may include “signature” and “no CVM” or other, as the biometric may or may not be considered a CVM for certain terminals.

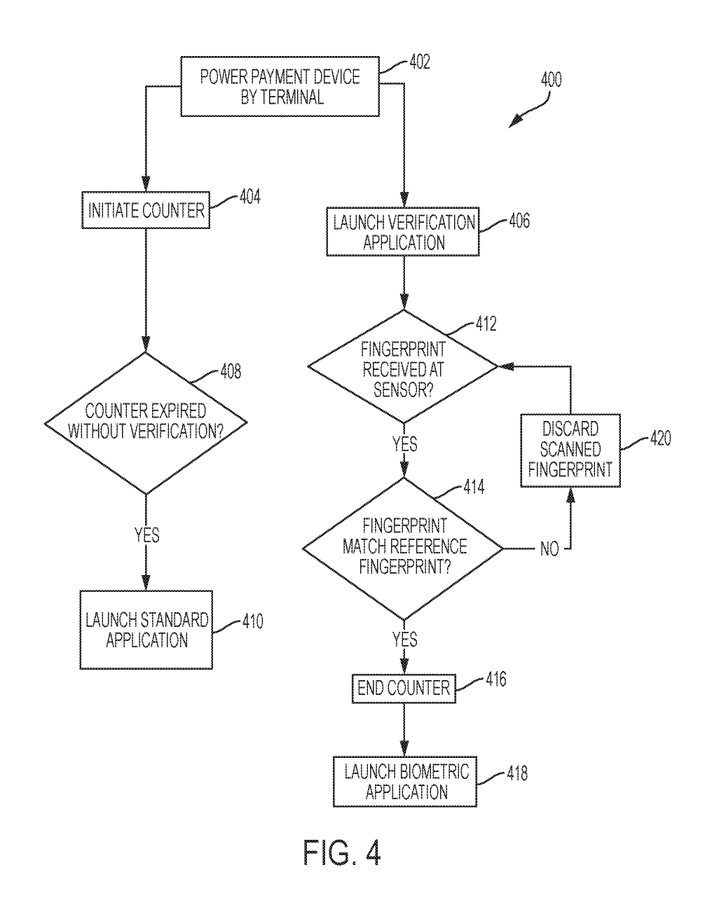

FIG. 4 illustrates an exemplary method 400 of verifying a user, in connection with a transaction using a payment device associated with the user 114. The method 400 is described below in connection with the exemplary system 100, the exemplary computing device 200, and the exemplary payment device 300 previously described. However, it should be appreciated that the method 400 is not limited to the system 100, or the computing device 200, or the payment device 300, but may be implemented in a variety of different systems and/or computing devices and/or payment devices. Likewise, the systems, computing devices, and payment devices described herein should not be understood to be limited to the exemplary method 400, or other methods described herein.

As previously described, the payment device 300 is issued to the user 114 by the issuer 108, and can be used in transactions, such as to purchase products from the merchant 102 or to effect verification of the user 114 to permit distribution of one or more benefits, for example, to deposit funds to the user's payment account, to distribute cash, goods or services to the user 114 at the merchant 102, etc.

Initially, when the user 114 attempts to distribute a benefit, at a terminal suitable to perform a biometric payment transaction, the user 114 indicates his/her intention to the merchant (if attended). The user then inserts the payment device 300 at least partially into the POS terminal 112, for example. In the illustrated method 400, when the payment device 300 is placed in contact with POS terminal 112 at merchant 102, power is provided to the payment device 300, at 402, by the POS terminal 112. In particular in method 400, the payment device 300 is powered by the POS terminal 112 when positioned in contact with, or when inserted at least partially into, the POS terminal 112.

Upon being powered at the POS terminal 112, the payment device 300 receives a “select” command from the POS terminal 112. In response, the payment device 300 initiates a counter, or counting feature, at 404, and launches a verification application, at 406.

The counter operates as a timer, and is configured to implement a predefined time period (or predefined count) to the user 114 to provide a fingerprint to the fingerprint sensor 308 of the payment device 300, when the payment device 300 is powered by the POS terminal 112, i.e., when the payment device 300 is in contact with the POS terminal 112, for use in effecting a transaction (e.g., a standard transaction, a biometric payment transaction, etc.). Or, the counter may include a feature in which WTX requests are counted, etc. In general, however, the payment device 300 responds to the WTX request (and other requests/commands, as necessary) until the verification application is complete or the time period expires. Then, if the security chip 302 determines the predefined time period expires or the count reaches the predefined number of WTX requests (i.e., the counter expiration), at 408, the payment device 300 abandons the execution of the verification application and responds to the select command from the POS terminal 112, by returning the AID of the standard payment application, thereby launching the standard application, at 410. For example, when a POS terminal 112, for example, swallows the entire payment device 300, and the fingerprint sensor is inaccessible, the predefined time period will expire, at which time the payment device will respond with the AID for the standard payment application. It should be appreciated that the duration of the predefined time, or the predefined number or count of WTX requests, may be defined, in some embodiments, depending on possible payment device performance, user convenience, one or more features of the POS terminal 112 (or other terminals), etc. In addition, the predefined time, or predefined number of counts when used, may include any desired time or number. The predefined count may provide an interval or delay of, for example, 1 second, 2 seconds, 3 seconds, 5 seconds, 15 seconds, or other suitable intervals, etc., potentially depending on, for example, payment device performance, user convenience, terminal timeout features, etc.

The verification application, launched by the payment device 300, at 406, is configured to monitor for a biometric, from the fingerprint sensor 308, during the predefined time period (or the predefined number of counts) over which the counter is active. In particular in the method 400, the payment device 300 continually, or intermittently, polls the fingerprint sensor 308 to determine if a finger is present at the sensor 308, at 412. When a fingerprint input is detected at the fingerprint sensor 308, the payment device 300 scans the finger and then assembles the data to reformat the fingerprint image as fingerprint data, as appropriate, for example, using feature extraction, etc. With the fingerprint data, the verification application, at the security chip 302, compares (i.e., performs a matching check of features, for example) the captured fingerprint data to the reference fingerprint data, at 414. When the captured fingerprint data matches the reference fingerprint data (e.g., when the user's fingerprint is valid, etc.), the payment device 300 sets the fingerprint verification field and exits, or ends, the verification application and terminates the counter, at 416. It is noteworthy that the security chip 302 is not required, in this embodiment, to separately check for a reference fingerprint in memory of the payment device 300 (prior to polling for the user's fingerprint), because if no reference fingerprint is stored, no match can be made at 414, and the counter, initiated at 404, will expire at 408. In one or more other embodiments, however, the security chip 302 may determine if a reference fingerprint is stored and terminates the verification application, if none is stored.

After the fingerprint is matched, and the counter terminates, the payment device 300 launches the biometric application, at 418. In particular, when the payment device 300 receives a valid fingerprint from the user 114, at 414, via the fingerprint sensor 308, the payment device 300 receives an application selection command from the POS terminal 112 (by a merchant attendant at an attended terminal, or by the user 114 at an unattended terminal) and responds with the biometric application identifier (i.e., the long AID for the biometric application). It should be appreciated that the payment device 300 sends the long AID for the biometric application, which includes a short AID common to both the biometric application and the standard application. Specifically, in this embodiment, the AIDs include a common Registered Application Provider Identifier (RID) and Proprietary Application Identifier Extension (PIX), but different PIX extensions. The POS terminal 112 only understands the root of the AIDs (or RID+PIX), such that the payment device 300 is able to provide two different long AID (i.e., one for the biometric application and one for the standard payment application), and the POS terminal 112 utilizes the same process in response (despite the payment device 300 acting differently). That is, the long AID for each application includes the same root AID, which the POS terminal 112 understands to be the conventional AID for the transaction (e.g., long AID's may be A000004101001 for the biometric application and A000004101002 for the standard payment application, wherein the short AID is A0000041010; etc.). The POS terminal 112 thus launches the same POS program (or application) to coordinate the transaction, based on the root AID, regardless of the long AID, sent by the payment device 300.

Subsequently, the POS terminal 112 proceeds with the transaction and sends an authorization request for the transaction to the issuer 108 (including a PAN or PAN+PSN (broadly, account number) specific to the biometric application). The issuer 108 recognizes the fingerprint verification status by the PAN and PAN+PSN in the authorization request from the POS terminal 112, as selected by the POS terminal, as being in a range of PANs or PAN+PSNs associated with biometric verification (and thus recognizes verification of the user 114).

It should be appreciated that despite the verification, the POS terminal 112 may not recognize the verification and/or the CVM for the payment device 300, and may indicate either PIN and/or signature verification is required. As such, the user 114 will be invited to take further steps for verification at the POS terminal 112. It should further be appreciated that the user 114 may complete different transactions, via the biometric application. For example, the user may cause a $0.00 transaction (or a status inquiry transaction) (by instructing the merchant 102, for example), whereby the mere receipt of the transaction requested (with the PAN and/or PAN+PSN) causes the issuer 108 to recognize verification of the user 114, which, in turn, distributes benefits to the user (e.g., by crediting or loading the benefit to the payment account associated with the payment device 300, etc.). Additionally, or alternatively, the user 114 may cause a purchase transaction, via the biometric application, whereby the issuer 108 is likewise informed of the verification, but the user 114 is further able to initiate a transaction for products.

Referring still to FIG. 4, if matching fails, at 414, however, the payment device 300 flushes the captured fingerprint image and/or discards the received fingerprint image, at 420, and continues to determine if a fingerprint is present at the fingerprint sensor 308.

It should be appreciated that initiating the counter, at 404, and launching the verification application, at 406, may be performed in any desired order and at any desired time. For example, the verification application may be launched, and then after, the counter may be initiated. In the illustrated method 400, however, the counter is initiated and the verification applications is launched by the payment device 300 at about the same, or substantially the same time.

As described above, conversely in the method 400, if the counter is expired, at 408, prior to, or without, achieving verification of the user 114 through the verification application, at 414, the payment device 300 launches the standard payment application, at 410. Specifically, for the standard payment application, the corresponding AID is returned, by the payment device 300, to the POS terminal 112. After which, the payment device 300 can be used in connection with a purchase transaction at the merchant 102. That said, the CVM for the payment device 300 may indicate either PIN and/or signature verification is required. Further, at this time, if the user 114 had no intention of completing a purchase transaction, but instead only intended identification of himself/herself, the user 114 may inform the merchant 102 of the same. And in response, the merchant 102 may cancel the transaction at the POS terminal 112, and the user 114 may then be invited to withdraw the payment device 300 from the POS terminal 112 and retry the transaction, as desired.

It should be appreciated that, in connection with launching the standard payment application, at 410, in the method 400, without achieving verification of the user 114 by the verification application, the resulting purchase transaction may have a different PAN (or the same PAN but a different PAN sequence number) than when the biometric application is launched after verification of the user 114 through the verification application. In this manner, the payment network 106 and/or the issuer 108 may be aware of verification by the type of transaction, i.e., a biometric payment transaction, and the PAN (or PAN+PSN) being within a particular range of PANs, etc.

Subsequently, regardless of whether the biometric application or the standard application are launched, the POS terminal 112 and the payment device 300 then cooperate to perform a desired transaction, (and as described in more detail in connection with the use case examples below). In particular, the payment device 300, and specifically the security chip 302, generates a cryptogram, i.e., an ARQC, based on data included in the payment device 300, and specifically based on the fingerprint verification field being set or not. In addition, the amount of the transaction is based on whether the merchant 102 and/or user 114 have selected a purchase transaction or a status check transaction, with the transaction amount being zero for the latter. In either case, the POS terminal 112 generates an authorization request, including the cryptogram, and sends the authorization request to the issuer 108, via the network 110 (as indicated above).

In some cases, it may happen that the acquirer 104 truncates a part of the authorization request, e.g., the DE 55, when the acquirer 104 (e.g., when the computing device 200 associated with the acquirer 104, etc.) is not capable of carrying it through the payment network 106 to the issuer 108. To compensate, the payment network 106 and/or issuer 108 may edit the authorization request content by adding SE 17 in DE 48, on the basis of the PAN registration or the PAN and a PAN+PSN for the user's account being with a particular, designated range.

In response to an (un-truncated) authorization request, the issuer 108 verifies the cryptogram and generates a further cryptogram, i.e., an ARPC, and sends it back through the payment network 106, via the network 110, to the payment device 300 at the POS terminal 112. The payment device 300 then verifies the cryptogram, and the transaction is completed. If, however, the authorization request is truncated, and the issuer 108 relied on the SE 17 in determining whether a fingerprint (or other biometric) has been verified, the issuer 108 does not return the cryptogram, because no cryptogram was received, by the issuer 108, upon which to generate the response cryptogram, i.e., the ARPC. The authorization response without the cryptogram is thus generated and returned to permit the transaction to be completed. Specifically, in this example, the issuer 108 employs ARQC validation if DE55 (or other part including the cryptogram) is present in the authorization request.

Consistent with conventional operations, purchase transactions are debited in the amount of the payment from the user's payment account in the clearing and settlement processes. For identification transactions, with a $0 amount, the acquirer 104, the payment network 106, and issuer 108 recognize that no clearing and settlement is necessary. Further, in cases where a benefit is to be loaded to the payment account associated with the payment device 300, the benefit is credited or loaded to the payment account either immediately, in some embodiments, or upon clearing and settling in others. Further, when delivery of products (e.g., goods or services, etc.) from the merchant 102 is the benefit to be distributed, the merchant 102, upon completion of the identification transaction may be prompted to deliver the products to the user 114. The merchant, if attended, may further require signature for distribution of benefits. Similarly, when the terminal is the ATM terminal 116, and the benefit is a cash distribution, the ATM terminal 116 may distribute the appropriate cash amount of the user 114 upon completion of the identification transaction, as described above.

In the above cases, it should be appreciated that various different arrangements and/or operations (in the same or other sequences) may be included in how the benefits are funded and/or exchanged between the merchant 102, the issuer 108, the user 114, and the source entity 118.

The details of the above interactions between the payment device 300 and the POS terminal 112, and the other parts of the system 100, are further illustrated in the non-limiting use examples provided below.

### EXAMPLE 1

The user 114 presents the payment device 300 to the POS terminal at the merchant 102. In response, the user 114 is verified, through the biometric verification application, upon which the biometric application is launched, to perform either a financial transaction such as purchase or cash withdrawal, or a non-financial transaction, such as status inquiry. In connection with this example, corresponding actions associated with the user 114, the POS terminal 112, the payment network 106, and the issuer 108 are provided in Table 1.

TABLE 1

| User 114 | POS Terminal 112 | Payment Network 106 | Issuer 108 |
|---|---|---|---|
| Fingerprint | Requests an online | Based on account ranges | Based on account ranges |
| captured and | status inquiry | (PAN/PSN), or if DE55 | (of PAN or PAN + PSN), |
| verified | (amount = $0, | is present and CVR is | or if DE55 is present and |
| (biometric | DE61/SF7 = 8) or an | personalized as | CVR is personalized as |
| application | ordinary | ‘fingerprint verified,’ | ‘fingerprint verified,’ |
| launched); | authorization request | the network adds a | the issuer 108 interprets |
| request for non- | (amount < or > $0)). | verification indicator | the status inquiry (amount = |
| financial or | | (e.g., SE17) to the | $0) as a request for social |
| financial | | request. | benefits. Otherwise, the |
| transaction. | | | issuer 108 proceeds to an |
| | | | ordinary non-financial |
| | | | request or authorization |
| | | | request. ARQC validation |
| | | | applies if DE55 is present. |

### EXAMPLE 2

The user 114 presents the payment device 300 to the POS terminal 112 at the merchant 102, but fails to complete verification by presenting a matching fingerprint to the payment device 300. In response, the standard payment application is launched, to perform either a financial transaction such as purchase or cash withdrawal, or a non-financial transaction, such as status inquiry. In connection with this example, corresponding actions associated with the user 114, the POS terminal 112, the payment network 106, and the issuer 108 are provided in Table 2.

TABLE 2

| User 114 | POS Terminal 112 | Payment Network 106 | Issuer 108 |
|---|---|---|---|
| No fingerprint | Requests an online | Based on account ranges | Based on account ranges, |
| captured (Standard | status inquiry | (PAN/PSN), the network | the issuer 108 proceeds to |
| M/Chip application is | (amount = $0, | does not add a | an ordinary non-financial |
| selected); request for | DE61/SF7 = 8) or an | verification indicator | request or authorization |
| non-financial or | ordinary | (e.g., SE17) to the | request. ARQC validation |
| financial transaction. | authorization request | request. | applies if DE55 is present. |
| | (amount < or > $0). | | |

It should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of: (a) initiating, by a security chip of a payment device, a timer after power-up of the security chip by a terminal, the payment device associated with a payment account; (b) capturing a biometric of a user, at a biometric sensor, when a biometric is present at the biometric sensor; (c) verifying, by the security chip, the captured biometric based on reference biometric data; (d) when the time is unexpired, and the captured biometric is verified, launching a biometric application, whereby the terminal appends a verification indicator and/or a first account number to an authorization request for a transaction to the payment account; (e) expiring the timer when the predefined number of waiting time extension requests is satisfied; (f) when the timer is expired, launching a standard payment application, whereby the terminal omits the verification indicator from the authorization request and appends a second account number in an authorization request for a transaction to the payment account, the first account number is different than the second account number; (g) generating, by the security chip, a cryptogram, based on the fingerprint verified field being set, when the biometric application is executed; and (h) transmitting the cryptogram to the terminal, whereby the cryptogram is included in the authorization request for a biometric payment transaction.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A payment device associated with a payment account, the device comprising:
a fingerprint sensor; and
a security chip coupled to the fingerprint sensor and including a standard payment application and a biometric application, the security chip configured to:
initiate a timer;
capture a fingerprint image, at the fingerprint sensor, when a finger is presented at the fingerprint sensor and when the timer is unexpired;
validate the captured fingerprint image against reference fingerprint data, stored in the payment device;
when the timer expires, without a match to the reference fingerprint data, launch the standard payment application to permit a transaction to the payment account using a first account number; and
when a match between the data for the captured fingerprint and the reference fingerprint data is found, while the timer is unexpired, launch the biometric application to permit a transaction to the payment account using a second account number, the first account number different from the second account number.

2. The device of claim 1, wherein the security chip includes an EMV chip; and
wherein the first account number and the second account number include the same primary account number (PAN), but different PAN sequence numbers (PSNs).

3. The device of claim 1, wherein one or more dimensions of the payment device are defined by a ID-1 standard; and
wherein the fingerprint sensor and the security chip are disposed at opposite end portions of the payment device, such that the security chip is able to be positioned to interact with a terminal, while the fingerprint sensor remains accessible to a user.

4. The device of claim 1, wherein the security chip is configured to respond to one or more waiting time extension (WTX) requests received from a POS terminal, while the timer is unexpired.

5. The device of claim 1, wherein the security chip is configured to transmit a first application identifier (AID) associated with the standard payment application and a second AID for the biometric application, at least a portion of the first AID and the second AID being the same.

6. The device of claim 1, wherein the security chip is configured to store the reference fingerprint data based on the captured fingerprint image, when no reference fingerprint data is stored in the payment device prior to the capture of the fingerprint image.

7. A system comprising the payment device of claim 1 and at least one of a payment network and/or an issuer, the at least one of the payment network and/or the issuer configured to:
intercept an authorization request associated with a transaction to the payment account, initiated by presenting said payment device, when the account number for the transaction is within a range of account numbers, or a card verification result (CVR) included in the authorization request indicates the card is biometric verified;
append a verification indicator to the intercepted authorization request; and
permit the authorization request associated with the transaction to proceed.

8. The system of claim 7, further comprising a terminal structured such that the fingerprint sensor is accessible to a user, when the security chip is in contact with the terminal; and
wherein the terminal is selected from the group consisting of a point-of-sale (POS) terminal and an automated teller machine (ATM) terminal.

9. A computer-implemented method for use in verifying users, in connection with transactions using payment devices, prior to distributing benefits to the users, the method comprising:
initiating, by a security chip of a payment device, a timer after power-up of the security chip by a terminal, the payment device associated with a payment account;
capturing a biometric of a user, at a biometric sensor, when a biometric is present at the biometric sensor;
verifying, by the security chip, the captured biometric based on reference biometric data;
when the time is unexpired, and the captured biometric is verified, launching a biometric application, whereby the terminal appends a verification indicator and/or a first account number to an authorization request for a transaction to the payment account; and
when the timer is expired, launching a standard payment application, whereby the terminal omits the verification indicator from the authorization request and appends a second account number in an authorization request for a transaction to the payment account, the first account number is different than the second account number.

10. The method of claim 9, wherein each of the first and the second account numbers includes a same primary account number (PAN) associated with the payment account.

11. The method of claim 10, wherein the security chip includes an EMV chip; and
wherein the first account number and the second account number include different PAN sequence numbers (PSNs).

12. The method of claim 9, further comprising:
generating, by the security chip, a cryptogram, based on the fingerprint verified field being set, when the biometric application is executed; and
transmitting the cryptogram to the terminal, whereby the cryptogram is included in the authorization request for a biometric payment transaction.

13. The method of claim 12, wherein the cryptogram is included at a field designated DE55 in the authorization request.

14. The method of claim 9, wherein initiating the timer includes counting a number of waiting time extension (WTX) requests received from the terminal, until a predefined number of WTX requests is counted; and
further comprising expiring the timer when the predefined number of WTX requests is satisfied.

15. The method of claim 14, wherein the terminal is selected from the group consisting of a point-of-sale (POS) terminal and an automated teller machine (ATM) terminal.

16. The method of claim 14, wherein the payment device includes the biometric sensor; and
wherein the biometric is a fingerprint, and the biometric sensor is a fingerprint sensor.

17. A non-transitory storage media including computer-executable instructions for selecting an application in a payment device, which, when executed by one or more processors, cause the one or more processors to:
initiate a counter of waiting time extension (WTX) requests received from a terminal providing power to the payment device;
detect and capture, at a fingerprint sensor of the payment device, a fingerprint of a user;
verify the captured fingerprint is consistent with reference fingerprint data;
execute one of a biometric application and a standard payment application, based on whether the captured fingerprint is verified;
generate a cryptogram when the captured fingerprint is verified and the biometric application is executed; and
transmit the cryptogram to the terminal, whereby the cryptogram is included in an authorization request for a transaction, such that, based on the content of the cryptogram, a source entity is able to verify the user and distribute one or more benefits thereto.

18. The non-transitory media of claim 17, wherein the executable instructions, when executed by the at least one processor, cause the at least one processor, in order to execute the one of the biometric application and the standard purchase application, to transmit a first application identifier (AID) to the terminal when the biometric application is executed and transmit a second AID to the terminal when the standard purchase application is executed; and
wherein the first AID and the second AID including a same root AID.

19. The non-transitory media of claim 17, wherein the executable instructions, when executed by the at least one processor, cause the at least one processor to further generate a different cryptogram when the captured fingerprint is not verified and the standard purchase application is executed and to transmit the different cryptogram to the terminal, whereby the different cryptogram is included in an authorization request.

20. The non-transitory media of claim 17, wherein the executable instructions, when executed by the at least one processor, cause the at least one processor to launch the standard payment application when the counter is expired.
